(19) United States
(12) Patent Application Publication
(10) Pub. No.: US 2003/0034335 A1
(43) Pub. Date: Feb. 20, 2003

(54) Laser cuttting apparatus

(76) Inventors: Hidetaka Goto, Ono-shi (JP); Katsuhito Hasegawa, Ono-shi (JP)

Correspondence Address: Ronald E. Greigg, Unite One Station Square, 1423 Powhatan Street, Alexandria, VA, 22314, US

(21) Appl. No.: 09/928,450

(22) Filed: Aug. 14, 2001

(51) Int. Cl. B23K 26/02

(52) U.S. Cl. 219/121.67; 219/121.82

(57) ABSTRACT

A laser cutting apparatus comprises a table for supporting a sheet such as a cloth in the form of a sheet in an unfolded state, a laser cutting device disposed to be movable desirably on a supporting surface for the sheet, and a vacuum device for sucking the sheet through suction openings, thereby the sheet may be cut with laser beam according to the desired movement of the laser cutting device.

### BACKGROUND OF THE INVENTION

The present invention relates to a laser cutting apparatus for making a desired laser cut to a sheet of such as a cloth in the form of a sheet.

As a cutting apparatus for required cutting processing of levelly spreaded cloth, such apparatus is suggested that it comprises a table with a level supportive plane supporting the cloth, movable members in back and forth directions while being guided by a guide mounted on both side of the table, and a cutting device movable in a longitudinal direction mounted to the movable member, and is structured to perform required cutting of cloth which is adhered to a surface of the table by vacuum. As the above-mentioned cutting devices, a cutting device equipped with a mechanical cutter like a knife, a cutting device utilizing laser beam and the like, have been adopted. The above-mentioned table has had a wide area of about 200 cm by 150 cm, for example.

However, the cutting apparatus according to the above-mentioned structure had the following problems.

(1) The cutting apparatus equipped with either of the cutting devices required a wide space for installment as the table supporting the cloth is installed levelly. For example, a wide space was required for installation of a table with a wide area of about 200 cm by 150 cm as mentioned-above.

Even with the cutting apparatus having a table of a wide area as mentioned above, there would not arise any particular problem as far as a space for installment is concerned in case fixed standardized goods are mass-produced at a factory. However, when cloth is cut for only a piece of dress as a trial in a room with limited space like a room for a development, or when cloth is cut only for a piece of dress to come up with a tendency of individualization in fashion these days, there was such a problem that it was difficult to install the above-mentioned cutting apparatus which required a wide space, unlike the case of a factory where enough space for installation was provided.

(2) In a conventional cutting apparatus, as a table of a wide area was levelly installed, it was hard to look over the whole sheet of cloth when performing, for example, the above-mentioned cutting conditions as a whole like a cutting balance.

(3) Further, in the above-mentioned cutting device equipped with the mechanical cutter like a knife, the whole weight becomes large, which requires that a transfer equipment for transferring the cutting device to a required position should necessarily be structured to be sturdy, wherefore there was a problem that the cutting apparatus as a whole became large scale.

(4) Furthermore, in the conventional cutting apparatus, when cloth is placed on the levelly installed table, human hands were required to tightly spread the cloth, which was also a problem.

### SUMMARY OF THE INVENTION

The present invention has an object to provide a laser cutting apparatus which may solve the above-mentioned problems.

To achieve the above object, the laser cutting apparatus according to the present invention comprises a table for supporting a sheet such as a cloth in an unfolded state and having a plurality of suction openings for fixing the sheet in a suction state; said table being disposed in an inclined state of predetermined angle with respect to a vertical plane or in a vertical state, a laser cutting device mounted on a supporting surface for supporting the cloth to be movable, and a vacuum device for sucking, through the openings, the sheet which is supported on the table, thereby the cloth is cut by means of laser beam according to movement of the laser device.

As a more detailed aspect, the laser cutting apparatus according to the present invention comprises a table for supporting a sheet such as a cloth in an unfolded state and having a plurality of suction openings for fixing the sheet in a suction state; said table being disposed in an inclined state of predetermined angle with respect to a vertical plane or in a vertical state, a movable member mounted on the table to be movable in up and down directions guided by means of a guide member which is arranged on the sides of the table, a laser cutting device mounted on the movable member to be movable in right and left directions along a longitudinal direction of the movable member, and a vacuum device for sucking, through the openings, the sheet which is supported on the table, thereby the cloth is cut by means of laser beam according to a predetermined amount of movement of the laser device.

In this case, it is preferable to comprise the apparatus such that the sheet is fed to the table by flowing the sheet from the upper end of the table to the lower end thereof.

Further, as another more detailed aspect, the laser cutting apparatus according to the present invention comprises a table for supporting a sheet such as a cloth in an unfolded state and having a plurality of suction openings for fixing the sheet in a suction state; said table being disposed in an inclined state of predetermined angle with respect to a vertical plane or in a vertical state, a movable member mounted on the table to be movable in right and left directions guided by means of guide members which are arranged at the upper and lower ends of the table, a laser cutting device mounted on the movable member to be movable in right and left directions along a longitudinal direction of the movable member, and a vacuum device for sucking, through the openings, the sheet which is supported on the table, thereby the cloth is cut by means of laser beam according to a predetermined amount of movement of the laser device.

In the laser cutting apparatus, it is preferable that an inclined angle of the table is adjustable.

Further, in the laser cutting apparatus, it is preferable to comprise that the table is structured to present a horizontal state.

### ADVANTAGES OF THE INVENTION

The laser cutting apparatus according to the present invention has a combined structure of a non-contact laser cutting device which can be structured lightly, and a table which is arranged to be inclined or to be vertical to the ground, making good use of advantages of the laser cutting machine. Thus, the combined structure of the present invention enables the cutting apparatus not only to perform delicate cutting (as cutting is performed by a microscopic condensing beam spot) efficiently and at high speed, which can never be achieved by a cutting device with a mechanical cutter like a knife, but also to show outstanding effects of substantially reducing the above mentioned installation space and of easily grasping cutting conditions as a whole. Further, as the cutting according to the present invention is performed without contact by laser but not the cutting by use of mechanical cutter like a knife, suction holes on the surface of the table does not form an obstacle, cut of the sheet of cloth can precisely be performed, and the whole structure of the cutting apparatus can be simplified. In addition, the laser cutting apparatus shows such excellent effects like efficient placing and removing of sheet of cloth, which is to be cut, on and from the surface of the table, and the like. The following is specific explanation of effects.

(1) As the laser cutting apparatus according to the present invention is so installed that the table is installed to be inclined or to be vertical to the ground, substantially reduction in an installation space can be attached compared to the conventional cutting apparatus in which a table is installed levelly.

Therefore, in case a laser cutting apparatus is to be installed in a room with a limited space like a room for a development department, for example, when a cloth is cut for only a piece of dress as a trial, or when a cloth is cut only for a piece of dress to come up with a tendency of individualization in fashion these days, such installation can be done without difficulty.

(2) As the table is installed in an inclined state or in a state vertical to the ground, unlike the conventional cutting apparatus in which table is installed levelly, enough distance from the table can be obtained to grasp such cutting conditions like cutting balance and the like, while looking over the whole sheet of cloth supported by the table, and therefore necessary adjustment in cutting is easy to perform.

(3) The laser cutting apparatus according to the present invention adopts a structure in which a sheet of cloth is cut by laser beam by way of lightweight laser cutting device which is moved as required along the surface of the table.

Of the conventional cutting apparatus, the above-mentioned cutting apparatus equipped with a cutting device using a mechanical cutter like a knife is heavyweight. So, there is not any particular problem in moving the above-mentioned apparatus in parallel to a level plane. However, when it comes to moving the heavy cutting apparatus in parallel to a inclined plane or to be the plane vertical to the ground, a sturdy equipment for moving is required in order to stably move the heavy cutting apparatus.

In the meantime, as the laser cutting device adopted in the present invention originally has such a very simple structure in which laser beam is refracted by a mirror as necessity requires, which refracted laser beam being condensed by a condensing lens, the laser cutting device is very lightweight. Consequently, it is not necessary at all to adopt a sturdy structure to move the laser cutting device in parallel to an inclined plane or to a plane vertical to the ground.

(4) According to the present invention, such structure is adopted that the table is inclined or is vertical to the ground, and that the sheet of cloth placed on the surface of the table for cutting is adhered to the table by a vacuum equipment. Therefore, after required cutting is finished, a piece of cloth which is cut off can easily be removed by free fall by the cloth's self-weight once the vacuum is released. In a conventional cutting apparatus having a level surface of a table, removal of a piece of cloth in this way is absolutely impossible.

(5) In the laser cutting apparatus according to this invention, as the surface of the table is inclined or is vertical to the ground, in case a guide is mounted on both sides of the table, a movable member movable up and down while being guided by the guide is mounted, and a laser cutting device is equipped so that the laser cutting device can be moved right and left along the longitudinal direction, when the apparatus is so structured that a sheet of cloth to be cut is streamed from an upper end toward the lower end of the table, the sheet of cloth automatically covers the surface of the table.

(6) In case the laser cutting apparatus according to the present invention is so structured that the table can also become level, when a sheet of cloth which is comparatively heavy is cut, cutting can be performed stably by placing the table levelly.

### BRIEF DESCRIPTION OF THE DRAWINGS

FIG. 1 is a side view showing a laser cutting apparatus according to the present invention,

FIG. 2 is a plan view showing FIG. 1, in the direction of arrows,

FIG. 3 is a sectional view showing a laser cutting device,

FIG. 4 is a descriptive view for describing a structure of honeycomb on the surface of a table, and

FIG. 5 is a plane view showing another aspect of the laser cutting apparatus according to the present invention.

### DETAILED DESCRIPTION OF THE PREFERRED EMBODIMENTS

Embodiments of this invention will be described below on the basis of the drawings.

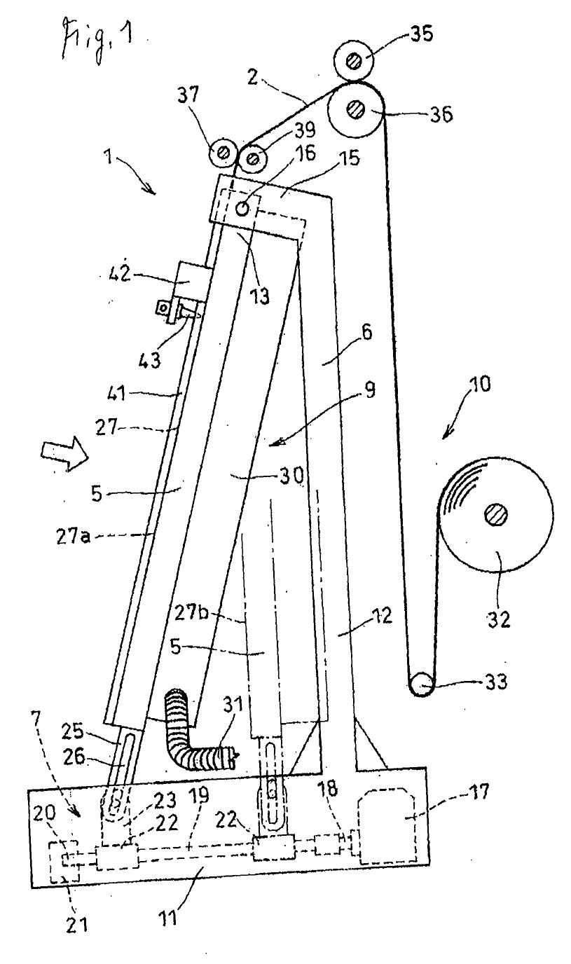

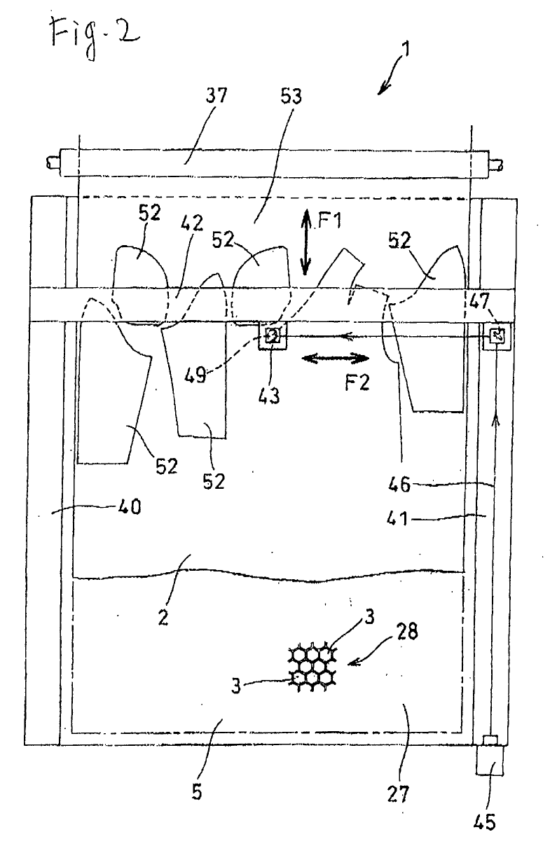

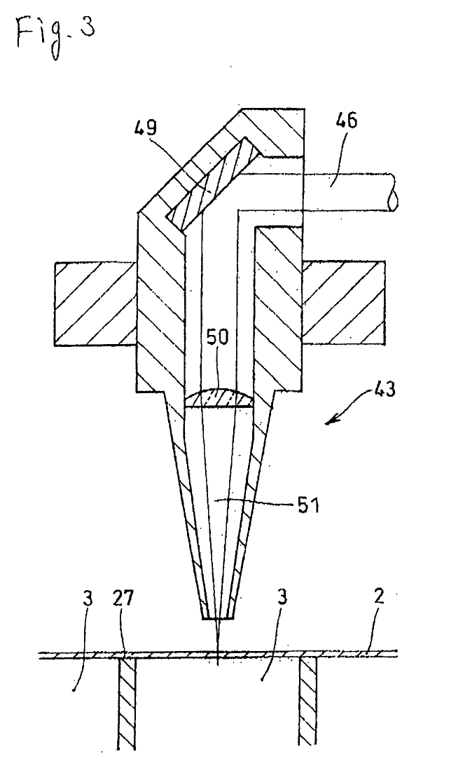

As shown in FIGS. 1 and 2, a laser cutting apparatus 1, according to this invention, is such structured that a table 5 for supporting a sheet (such as a cloth) in an unfolded state and having a number of suction openings 3, is mounted onto a base frame 6 in a desired inclined state or in a vertical state while sucking the sheet, and that the inclined angle of the table 5 is adjustable by means of an angle adjusting device 7. Further, a vacuum device 9 is structured to suck the sheet 2 via the suction openings 3, as shown in FIGS. 2 and 3. Supply of the sheet 2 to the table 5 is carried out by means of a sheet feeding device 10, which is mounted onto the base frame 6, as shown in FIG. 1.

The base frame 6 is so structured that a vertical frame 12 is standing on the base frame at the outer ends of a level frame 11. An upper end portion 13 of the table 5 is connected to an upper end portion 15 of the level frame 12 by means of a pivotal shaft 16, so that the table 5 may be rotated within a vertical plane.

Further, the angle adjusting device 7 is structured as follows. Namely, arranged levelly is a screw shaft 19, which extends to a rotary shaft 18 of an electric motor 17, which is disposed on the side of the base end of the level frame 11, and a tip end 20 of the screw shaft is supported rotatably by means of a bearing 21 which is disposed on the side of the tip end of the level frame 11, and a nut 22 is screwed to the rotary shaft 19. A connecting member 23 is made to project from the nut 22. The tip end of the connecting member 23 is pivoted to an arm 25, via a slide slit 26 extending in the up and down directions, said arm being made to project from the lower end of the table 5. Therefore, the table 5 may change its inclined angle in response to the forward and backward movements of the nut 22, accompanying the rotation of the rotary shaft 19. Using a solid line, FIG. 1 shows a state that the table 5 is inclined with respect to a vertical plane, and the vertical state of the table 5 is shown with a chain line in FIG. 1.

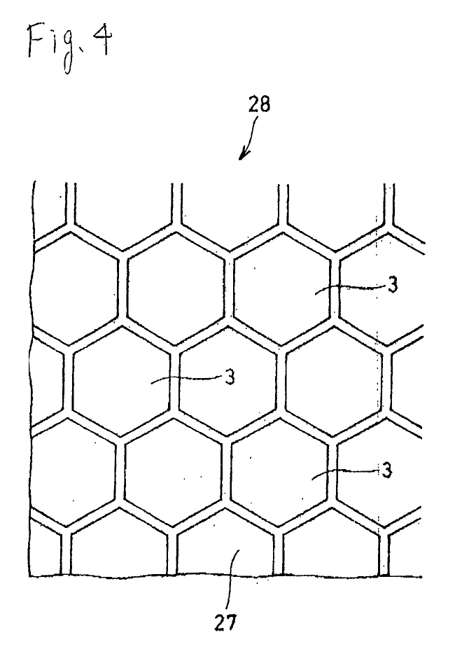

Further, the table 5 is, for example, formed to be a rectangular which has long sides of 200 cm and short sides of 150 cm. A supporting surface 27 (referred to as a table surface hereinafter) for supporting the sheet 2, is formed to be a honeycomb 28, as shown partially in FIGS. 2 and 4, for example. With a desired angle adjustment by means of the angle adjusting device 7, the table surface 27 for supporting the sheet 2, is formed to be an inclined surface 27a, as shown with a solid line in FIG. 1, or a vertical surface 27b, as shown with a chain line in FIG. 1.

The vacuum device 9 is structured such that a suction tube 31 is connected to the reverse side of the table 5, which is provided with the honeycomb 28 having a number of the suction openings 3 in the form of a hexagon, as shown, for example, in FIGS. 1 and 3. When vacuum is generated in a suction box 30 by operating a blower, the sheet 2 is sucked onto the table surface 27, via the suction openings 3.

Further, the sheet feeding device 10, is so structured that a sheet roll 32, which rolls the sheet 2 to be cut, may be unrolled desirably by means of an electric motor which is not shown, as shown in FIG. 1, and the unrolled sheet is introduced into catching rollers 35, 36 and 39, which are positioned at the upper end of the base frame in such a state that the sheet is supporting a weight roll 33 in a free state, and then the sheet 2, may be flown from the upper end of the table surface 27 toward the lower end thereof, said sheet 2 being unrolled from the sheet roll 32, with the forcible rotation of the catching rolls by the electric motor, which is now shown.

As shown in FIGS. 1 and 2, on the right and left sides of the table 5, there is provided guides 40 and 41, which are extending up and down directions, so that a movable member 42 may be moved up and down (as shown with an arrow F1) as guided by the guides 40 and 41. The movable member 42 is provided with a laser cutting device 43 which is movable in a longitudinal direction (right and left directions) of the movable member (as shown with an arrow F2). Since the movable member 42 is so arranged to bridge the table surface 27, it is not afraid that the movement of the movable member 42 contacts the sheet 2 which is sucked on the table surface 27. The laser cutting device 43 may be moved desirably on the table surface 27 which is in an inclined state or a vertical state.

Further, the laser cutting device 43 is structured as follows in FIGS. 2 and 3. Laser beam 46, emitted from a laser generating device 45 which is arranged at the lower end of a side of the table 5, is introduced into a condensing lens 50, via a mirror 47 which is disposed on a side of an end of the movable member 42, and via a mirror 49 which is provided with the laser cutting device 43. Condensed beam 51, which is condensed by the condensing lens 50, focuses on the sheet 2, as shown in FIG. 3. Thus, the sheet 2 may be cut desirably with movement of the condensed beam 51 due to the desired movement of the laser cutting device 43.

Accordingly, where giving laser cutting to the sheet 2 which is supported on the table surface 27, by using the laser cutting apparatus 1 which is as structured above, the sheet 2 is supplied onto the table surface 27, with a desired feeding movement of the sheet feeding device 10, so as to make such a state that the sheet 2 covers the table surface 27 which is in an inclined state or a vertical state. In this state, the vacuum device 9 is operated so as to suck the sheet 2 onto the table surface 27, via the suction openings 3, with its vacuum function.

In such a state that the sheet 2 is sucked, the laser cutting device 43 is moved desirably under computer control. With the movement of the condensed beam 51 accompanying the movement of the laser cutting device 43, the sheet 2 may be cut desirably, as shown in, for example, FIG. 2. After finish of cutting, when vacuum function of the vacuum device 9 is released, a cut-sheet piece 52, which is shown in FIG. 2, falls freely due to its weight so that it may be removed away from the table 5. By the way, where giving laser cutting to an upper edge portion 53 (FIG. 2) of the sheet 2 on the table surface 27, it becomes possible to fall whole of the sheet on the table surface due to its weight at the time when the said vacuum function is released.

As to the cutting state by the laser cutting device 43, it may easily grasp cutting conditions such as a cutting balance by moving away from the table 5 for a predetermined distance, because the table 5 is in an inclined state or a vertical state.

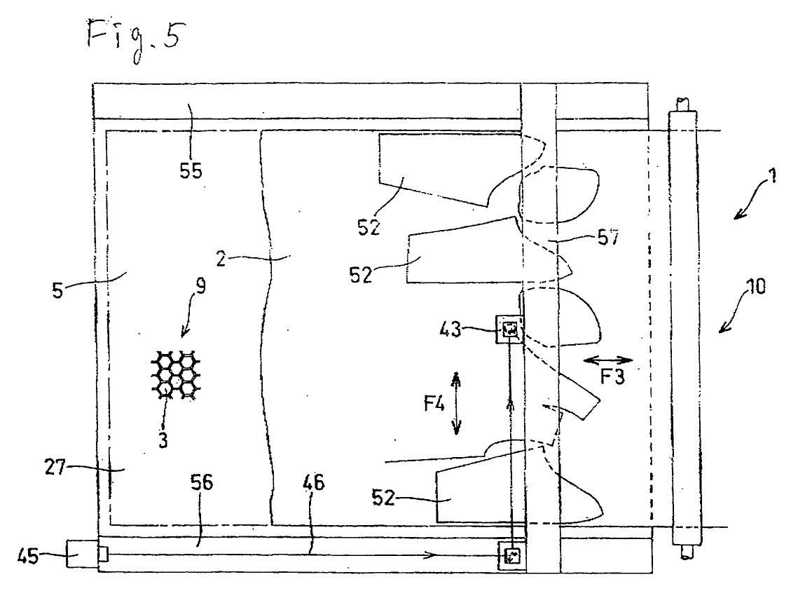

FIG. 5 shows another aspect of the laser cutting apparatus 1 according to this invention, and in the same manner as mentioned above, guides 55 and 56 extending in the right and left directions, are provided with the upper and lower ends of a table 5 which is mounted on a base frame in such a state that the table is in an inclined state or a vertical state with respect to a vertical plane, so that a movable member 57 may be moved right and left (as shown with an arrow F3) as guided by upper and lower guides 55 and 56. Provided with the movable member 57 is a laser cutting device 43 which is movable in its longitudinal direction (up and down directions) of the movable member (as shown with an arrow F4). Since the movable member 57 is arranged to bridge the table surface 27, it is not afraid that movement of the movable member 57 makes a contact of the movable member with the sheet 2 which is sucked onto the table surface 27. The laser cutting device 43 may be moved desirably on the table surface 27, which is in an inclined state or a vertical state according to computer control.

In the other points of view, the structure of the vacuum device 9 and the structure of the laser cutting device 43 are the similar to the above, but there is a different from the above that the sheet feeding device 10 is so structured to feed the sheet 2 in right and left directions.

Accordingly, where giving laser cutting to the sheet 2 which is supported on the table surface 27, by using the laser cutting apparatus 1 which is as structured above, the sheet 2 is supplied onto the table surface 27 in right and left directions, with a desired feeding movement of the sheet feeding device 10, so as to make such a state that the sheet 2 covers the table surface 27 which is in an inclined state or a vertical state. In this state, the vacuum device 9 is operated so as to suck the sheet 2 onto the table surface 27, via the suction openings 3, with its vacuum function.

In such a state that the sheet 2 is sucked, the laser cutting device 43 is moved desirably under computer control. With the movement of a condensed beam accompanying the movement of the laser cutting device 43, the sheet 2 may be cut desirably, as shown in, for example, FIG. 5. After finish of cutting, when vacuum function of the vacuum device 9 is released, a cut-sheet piece 52 falls freely due to its weight so that it may be removed away from the table 5. At the time, it is preferable to move the movable member 57 toward the right end or the left end so that the falling cut-sheet piece 52 may not be hooked.

Other Aspects of Embodiments

(1) In the laser cutting apparatus of this invention, means for moving the laser cutting device 43 on the table surface 27 desirably is not limited to one which is shown in the aspect of embodiment.

(2) The sheet may be those such as a plastic film, a real leather, an artificial leather and the like which may be cut with laser beam, other than the above-mentioned cloth.

(3) The table surface for supporting the sheet may be structured with slit construction and the like other than the above-mentioned honeycomb in case that it may support the sheet for laser cutting, and that it may be provided with a vacuum device for sucking the sheet via suction openings.

(4) In the laser cutting apparatus, the table 5 may be further structured to present a level state, if desired.

What is claimed is:

1. A laser cutting apparatus comprising
a table for supporting a sheet such as a cloth in unfolded state and having a plurality of suction openings for fixing the sheet in a suction state; said table being disposed in an inclined state of predetermined angle with respect to a vertical plane or in a vertical state,
a laser cutting device mounted on a supporting surface for supporting the cloth to be movable, and
a vacuum device for sucking, through the openings, the sheet which is supported on the table,
thereby the cloth is cut by means of laser beam according to movement of the laser cutting device.

2. A laser cutting apparatus comprising
a table for supporting a sheet such as a cloth in unfolded state and having a plurality of suction openings for fixing the sheet in a suction state; said table being disposed in an inclined state of predetermined angle with respect to a vertical plane or in a vertical state,
a movable member on the table to be movable in up and down directions guided by means of guides which are arranged on the sides of the table,
a laser cutting device mounted on the movable member to be movable in right and left directions along a longitudinal direction of the movable member, and
a vacuum device for sucking, through the openings, the sheet which is supported on the table,
thereby the cloth is cut by means of laser beam according to movement of the laser cutting device.

3. A laser cutting apparatus as claimed in claim 2, wherein the sheet is fed to the table by flowing the sheet from the upper end of the table to the lower end thereof.

4. A laser cutting apparatus comprising;
a table for supporting a sheet such as a cloth in unfolded state and having a plurality of suction openings for fixing the sheet in a suction state; said table being disposed in an inclined state of predetermined angle with respect to a vertical plane or in a vertical state,
a movable member on the table to be movable in right and left directions guided by means of guides which are arranged at the upper and lower ends of the table,
a laser cutting device mounted on the movable member to be movable in up and down directions along a longitudinal direction of the movable member, and
a vacuum device for sucking, through the openings, the sheet which is supported on the table, thereby the cloth is cut by means of laser beam according to movement of the laser cutting device.

5. A laser cutting apparatus as claimed in claim 1, wherein an inclined angle of the table is adjustable.

6. A laser cutting apparatus as claimed in claim 2, wherein an inclined angle of the table is adjustable.

7. A laser cutting apparatus as claimed in claim 3, wherein an inclined angle of the table is adjustable.

8. A laser cutting apparatus as claimed in claim 4, wherein an inclined angle of the table is adjustable.

9. A laser cutting apparatus as claimed in claim 1, wherein the table is structured to present a horizontal state.

10. A laser cutting apparatus as claimed in claim 2, wherein the table is structured to present a horizontal state.

11. A laser cutting apparatus as claimed in claim 3, wherein the table is structured to present a horizontal state.

12. A laser cutting apparatus as claimed in claim 4, wherein the table is structured to present a horizontal state.

13. A laser cutting apparatus as claimed in claim 4, wherein the table is structured to present a horizontal state.
